(19) United States
(12) Patent Application Publication
(10) Pub. No.: US 2026/0005911 A1
(43) Pub. Date: Jan. 1, 2026

(54) SYSTEM AND METHOD FOR MULTI-TIER NETWORK REPOSITORY FUNCTION

(71) Applicant: JIO PLATFORMS LIMITED, Ahmedabad (IN)

(72) Inventors: Aayush BHATNAGAR, Navi Mumbai (IN); Aditya Kumar GUPTA, Karnal (IN); Apoorva KHAMESRA, Udaipur (IN)

(73) Assignee: JIO PLATFORMS LIMITED, Ahmedabad (IN)

(21) Appl. No.: 18/869,206

(22) PCT Filed: May 27, 2023
(86) PCT No.: PCT/IB2023/055455

§ 371 Date: Nov. 25, 2024

(30) Foreign Application Priority Data
May 30, 2022 (IN) 202221030938

(51) Int. Cl. H04L 41/044; H04W 40/02; H04W 84/04

(52) U.S. Cl. CPC H04L 41/044; H04W 40/02; H04W 84/042

(57) ABSTRACT

The present disclosure relates to a network repository function architecture for a telecommunication network. The telecommunication network includes a multi-tiered network repository function (NRF) architecture serving one or more network functions (NFs) associated with the telecommunication network, where the multi-tiered NRF includes a centralized NRF associated with one or more local NRFs, wherein at least one of the one or more local NRFs receives a NF service request associated with a serving public land mobile network (PLMN), determines whether the NF service request is processed by the local NRF, and forwards the NF service request to the centralized NRF based on the local NRF being unable to process the NF service request.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to a core network repository function in fifth generation (5G) communication system. In particular, the present disclosure relates to a multi-tiered network repository function architecture in 5G communication system.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In a fifth generation (5G) mobile network, a Network Repository Function (NRF) stores one or more Network Functions (NFs). The NRF is a management function maintaining data and profiles related to the NF. The 5G network may include a single NRF or multiple NRFs for managing the NFs associated with the network. For networks with multiple NRFs, there are a few challenges associated with managing the multiple NRFs and their interrelations. Further, the NFs in the network may be associated with one or more NRFs necessitating techniques for manging the interrelations of NFs associated with different NRFs.

There is, therefore, a need in the art to provide a method and a system that can overcome the shortcomings of the existing prior arts.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for managing routing in a multi-tiered network repository function (NRF) architecture comprising a centralized NRF associated with one or more local NRFs, said system including one or more processors and a memory operatively coupled to the one or more processors, wherein the memory includes processor-executable instructions, which on execution, cause the one or more processors to receive an NF service request associated with a serving public land mobile network (PLMN), determine whether the NF service request is processed by a local NRF of the one or more local NRFs, and forward the NF service request to the centralized NRF based on the local NRF being unable to process the NF service request.

In some embodiments, the first local NRF is unable to process the NF service request based on the NF service request being in a suspended state.

In some embodiments, the centralized NRF serves as a gateway for servicing one or more NRFs associated with a telecommunication network, and may be independently deployed centralized NRF or a combinational NRF, wherein the combinational NRF includes the centralized NRF deployed within at least the one or more local NRFs. Further, the centralized NRF routes an NF service request associated with a first local NRF to a second local NRF based on one or more routing tables associated the centralized NRF.

In some embodiments, the first local NRF and the second local NRF are associated with the same PLMN. In some other embodiments, the first local NRF is associated with a first PLMN and the second local NRF is associated with a second PLMN, wherein the second PLMN is associated with a roaming partner (RP).

In some embodiments, the centralized NRF routes the NF service request to the second local NRF associated with the second PLMN through a security edge protection proxy (SEPP).

In another aspect, the present disclosure relates to a method for routing an NF service request in a local NRF. The method may include receiving, at a PLMN interface, the NF service request associated with a serving PLMN, determining, by a determination unit, based on one or more parameters whether the NF service request is processed by the local NRF, wherein the one or more parameters include at least one of a target PLMN, a single network slice selection assistance information (S-NSSAI), and a type of NF (NF Type), and forwarding, through a centralized NRF interface, the NF service request to a centralized NRF based on the local NRF being unable to process the NF service request. In some embodiments, the method may include processing, by the one or more processors, the NF service request at the local NRF based on the one or more parameters.

In one another aspect, the present disclosure relates to a method of routing an NF service request in a centralized NRF. The method may include receiving, at a local NRF interface, the NF service request associated with a serving PLMN from a first local NRF, determining, by a determination unit, a route for the NF service request based on a routing table and PLMN information stored in a database, wherein the routing table includes information related to at least one of a priority value, a target PLMN, a type of NF (NF Type), a slice number, an action to be taken, and an NRF table, and forwarding, through the local NRF interface, the NF service request to a second local NRF based on the determined route.

In some embodiments, the second local NRF may be associated with at least one of the serving PLMN, a second access technology independent network, and an RP.

In some other aspects, the present disclosure relates to a non-transitory computer readable medium including one or more instructions stored thereupon that when executed by a processor causes the processor to receive an NF service request associated with a first local NRF in a PLMN, determine a route for the NF service request to a second local NRF based on a routing table and PLMN information from a database, and forward the NF service request to the second local NRF based on the determined route.

### OBJECTS OF THE PRESENT DISCLOSURE

Some of the objects of the present disclosure, which at least one embodiment herein satisfies are as listed herein below.

It is an object of the present disclosure to provide a hierarchical network repository function (NRF) architecture.

It is an object of the present disclosure to provide multiple NRFs for a particular public land mobile network (PLMN).

It is an object of the present disclosure to provide multiple NRFs for same slice.

It is an object of the present disclosure to provide a combinational NRF for smaller deployments.

It is an object of the present disclosure to create NRF forwarding policy.

It is an object of the present disclosure to provide a centralized inventory for network functions (NFs) associated with all the NRFs.

It is an object of the present disclosure to provide a centralized NRF management towards local NRFs.

It is an object of the present disclosure to provide centralized state data maintenance.

It is an object of the present disclosure to enhance the network management capabilities.

It is an object of the present disclosure to optimize the network functions.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an exemplary fifth generation (5G) network architecture (100) comprising a multi-tiered network repository function (NRF), in accordance with an embodiment of the present disclosure.

FIG. 2A illustrates an exemplary multi-tiered NRF hierarchy (200-A), in accordance with an embodiment of the present disclosure.

FIG. 2B illustrates an exemplary multi-tiered NRF hierarchy (200-B) with a combinational NRF, in accordance with an embodiment of the present disclosure.

FIG. 3 illustrates an exemplary message flow diagram (300) associated with subscription messages between different entities in the 5G network architecture (100), in accordance with an embodiment of the present disclosure.

FIG. 4 illustrates an exemplary message flow diagram (400) associated with servicing a local network function (NF) in a public land mobile network (PLMN) by a local NRF, in accordance with an embodiment of the present disclosure.

FIG. 5 illustrates an exemplary message flow diagram (500) associated with servicing the local NF in the PLMN by another local NRF, in accordance with an embodiment of the present disclosure.

FIG. 6 illustrates an exemplary message flow diagram (600) associated with servicing the local NF in the PLMN by a local NRF of another access technology independent network, in accordance with an embodiment of the present disclosure.

FIG. 7 illustrates an exemplary message flow diagram (700) associated with servicing the local NF in the PLMN by a local NRF in another PLMN, in accordance with an embodiment of the present disclosure.

FIG. 8 illustrates an exemplary message flow diagram (800) associated with servicing a subscription request from the local NF in the PLMN by another local NRF, in accordance with an embodiment of the present disclosure.

FIG. 9 illustrates an exemplary message flow diagram (900) associated with servicing a subscription request from the local NF in the PLMN by a local NRF of another access technology independent network, in accordance with an embodiment of the present disclosure.

FIG. 10 illustrates an exemplary message flow diagram (1000) associated with servicing a subscription request from the local NF in the PLMN by a local NRF in another PLMN, in accordance with an embodiment of the present disclosure.

FIG. 11A illustrates an exemplary message flow diagram (1100-A) associated with remote NF discovery serviced by the local NRF, in accordance with an embodiment of the present disclosure.

FIG. 11B illustrates an exemplary message flow diagram (1100-B) associated with remote NF subscription request serviced by the local NRF, in accordance with an embodiment of the present disclosure.

FIG. 12 illustrates an exemplary representation of a system (1200) with which or in which the centralized NRF may be implemented, in accordance with an embodiment of the present disclosure.

FIG. 13 illustrates an exemplary representation of a system (1300) with which or in which the local NRF may be implemented, in accordance with an embodiment of the present disclosure.

FIG. 14 illustrates an exemplary computer system (1400) in which or with which embodiments of the present disclosure may be implemented.

The foregoing shall be more apparent from the following more detailed description of the disclosure.

### DETAILED DESCRIPTION OF DISCLOSURE

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure provides a robust and effective solution for creating a multi-tiered network repository function (NRF) architecture providing a centralized management of local NRFs associated with a public land mobile network (PLMN). The present disclosure also provides a centralized inventory of all the network functions (NFs) associated with all the NRFs.

Embodiments of the present disclosure relate to creating a multi-layered NRF architecture for serving NFs associated with various local NRFs across different PLMNs. In an example embodiment, a fifth generation (5G) communication network includes two-tier NRF architecture for each PLMN or an access technology independent network present in the 5G network. The two-tier NRF architecture includes an upper tier and a lower tier. The upper tier includes a centralized NRF, and the lower tier includes multiple local NRFs. The NFs associated with the 5G network excepting security edge protection proxy (SEPP) may register only with local NRFs. The SEPP may register with the centralized NRF and may be connected to the centralized NRF either directly or through a service communication proxy (SCP). The centralized NRF present in a particular PLMN or an access technology independent network may communicate with other centralized NRFs which may be present in other PLMNs or access technology independent networks. By way of example, without limitations, the centralized NRF may also communicate with the SEPP.

In certain embodiments, the local NRFs may be divided into two categories: 1. multi slice or shared slice where a single NRF provides support for more than one slice, and 2. single slice or dedicated slice where the single NRF provides support for a single slice.

In accordance with some embodiments, the centralized NRF may serve as an end point for providing services such as, but not limited to, Subscribe/UnSubscribe/Discovery/AccessToken/Notify/ListRetrieval/ProfileRetrieval/Bootst rapping, etc., for the SEPP and local NRFs. In accordance with some embodiments, the centralized NRF may forward the service requests limitations, Discovery/Access Token/Bootstrap/Ping Request from NFs associated with a serving PLMN towards other NRFs of the same PLMN or towards NRFs present in other PLMN, wherein the other NRFs of other PLMN are associated with another access technology independent network. Further, if the PLMN belongs to a different operator, the centralized NRF may forward the service requests to the SEPP. The centralized NRF performs the forwarding based on a user-defined route forwarding table.

In some embodiments, the centralized NRF may be deployed as an independent entity. In some other embodiments, the centralized NRF may be deployed as a separate logical entity within the local NRF i.e., the local NRF may be a single container holding the functionality of both the local and centralized NRFs. A network provider may have the option to select the type of deployment for the NRF.

In some embodiments, the network provider may have a configuration flag related to an option of having either a single NRF per PLMN or a multi-tier NRF deployment with only single mode that may work at a given time.

Certain terms and phrases have been used throughout the disclosure and will have the following meanings in the context of the ongoing disclosure.

The term “PLMN” may refer to public land mobile network and form a mobile operator's cellular network in a particular country represented by a unique PLMN code.

The term “NRF” may refer to network repository function serving as a central registration center for all the core network components, for example, network functions (NFs).

The term “NF” may refer to network function providing processing functionality in 5G networks.

The term “SEPP” may refer to security edge protection proxy enabling secure interconnect between 5G networks ensuring end-to-end confidentiality and/or integrity between source and destination network for all 5G interconnect roaming messages.

The term “SCP” may refer to service communication proxy providing a decentralized solution. The SCP comprises control plane and data plane and is deployed along side of NF to provide routing control, resiliency, and observability to the core network.

The term “access technology independent network” may refer to a network infrastructure where all the network operators are connected to a single core with a single infrastructure, regardless of type of access technology employed.

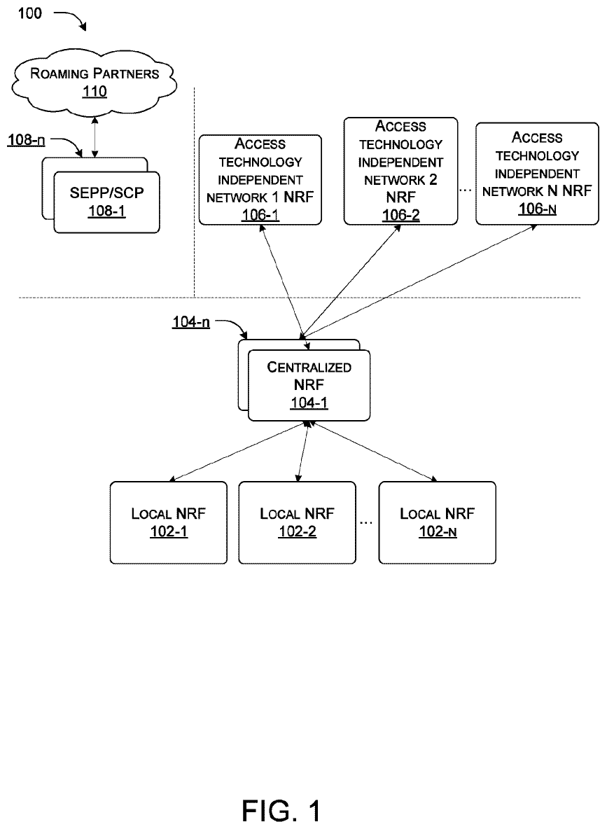

The various embodiments throughout the disclosure will be explained in more detail with reference to FIGS. 1-14.

FIG. 1 illustrates an exemplary 5G network (100) comprising a multi-tiered NRF architecture, in accordance with an embodiment of the present disclosure.

In FIG. 1, a telecommunication network, for example, a 5G network (100) comprising local NRFs (102-1, 102-2 . . . 102-n), centralized NRFs (104-1, 104-2 . . . 104n) corresponding to each access technology independent network (106-1, 106-2 . . . 106-n), and security exchange protection proxies (SEPPs) (108-1 . . . 108-n) connected to roaming partners (RPs) (110), is shown. In some embodiments, the local NRFs (102-1, 102-2 . . . 102-n), which may collectively be represented as local NRFs (102), may be connected to any one of the centralized NRFs (104-1, 104-2 . . . 104-n) corresponding to any one of the access technology independent networks (106-1, 106-2 . . . 106-n), respectively. The centralized NRFs (104-1, 104-2 . . . 104-n) may collectively be represented as centralized NRF (104). Similarly, the one or more access technology independent networks (106-1, 106-2 . . . 106-n) may collectively be represented as access technology independent network (106) and the one or more SEPPs (108-1 . . . 108-n) may collectively be represented as SEPP (108).

Referring to FIG. 1, the local NRFs (102) are connected to the centralized NRF (104) associated with the access technology independent network (106). The centralized NRF (104) may forward request from NFs associated with the local NRF (102) based on a routing table. In an example embodiment, the centralized NRF (104) may forward the NF request received through the local NRF (e.g., 102-1) to another local NRF (e.g., 102-2) within the same access technology independent network (106-1), wherein the local NRF (102), the centralized NRF (104), and the access technology independent network (106-1) belong to a serving PLMN i.e., PLMN of a first operator. In another example, the centralized NRF (104-1) may forward the NF request received through the local NRF (102) associated with one access technology independent network (106-1) to another local NRF (not shown) associated with another access technology independent network (106-n) based on the target PLMN data in the received request. The local NRF (102), the access technology independent network (106-1, 106-n), the centralized NRF (104-1, 104-n), and another local NRF are associated with the serving PLMN. In one another example, the centralized NRF (104) may forward the NF request received through the local NRF (102) to another NRF (not shown) associated with another PLMN i.e., the PLMN different from the serving PLMN i.e., roaming partners (110) through the SEPP (108).

In some embodiments, the NF request may include, for example, without limitations, a Subscribe/Discovery/UnSubscribe/Access Token/Bootstrapping request. In some embodiments, service operations such as NF Register/NF Update/NF Deregister/NF Status Notify/NF List Retrieval/NF Profile Retrieval may work with the associated local NRF (102) and the centralized NRF (104) and may not be forwarded to other NRFs unless there is any indication provided through notification uniform resource identifier (URI). For other requests, such as, without limitations, Subscribe/Discovery/UnSubscribe/Access Token/Bootstrapping, the local NRF (102) may determine if it can serve the request locally, and if not, the local NRF (102) may forward the request to the centralized NRF (104). If the local NRF (102) is able to serve the request locally, the local NRF (102) may authorize such request before serving relevant attributes, for example, without limitations, reqNf Type, reqNfFqdn, reqSnssais, reqPerPlmnSnssais, reqPlmn List, reqSnpn List, etc. On the other hand, if the local NRF (102) is not able to serve the NF request, the local NRF (102) may check information, such as, without limitations, a target PLMN, a NF Type served by the local NRF (102), network slices served by the local NRF (102), etc., and may decide to forward the NF request towards the centralized NRF (104). If the local NRF (102) cannot serve the NF request locally (or has a null set match), it may forward the request to the centralized NRF (104) provided the centralized NRF (104) has not forwarded the request earlier to avoid creating a loop. The local NRF (102) may manually mark NF requests that cannot be served by itself as “Undiscoverable” so that the subscribe/discover response for those NFs may be considered for null match and may be forwarded towards the centralized NRF (104). In an embodiment, the centralized NRF (104) may not route back a request received from the local NRF (102-1) to the same local NRF (102-1). In other words, the multi-tier architecture (100) avoids loop creation. Also, the local NRF (102-1) may not forward the request forwarded by the centralized NRF (104) to any other local NRF or another centralized NRF, unless specified by a separate feature.

In accordance with some embodiments, the local NRF (102) may register, update, or deregister with the centralized NRF (104) during a runtime configuration of the centralized NRF (104) by a user.

In some embodiments, when the centralized NRF (104) receives a NF request forwarded by the local NRF (102), the centralized NRF (104) may check for the target PLMN based on an associated parameter for service operation with the NF request to determine if the request should be forwarded towards the SEPP (108) or other access technology independent network NRF (106) or towards the local NRF (102). In case target PLMN is absent, that requestor PLMN i.e., the PLMN associated with the requested NF may be considered as the target PLMN. The centralized NRF (104) may include a table comprising details required to decide on how to forward the NF request. The details may include, for example, without limitations, an access technology independent network NRF table for communicating or forwarding requests with other access technology independent network NRFs, a centralized routing table comprising internet protocol (IP) address and port number associated with SEPPs (108) for forwarding request towards PLMNs other than the serving or home PLMN, and a local NRF table associated with the local NRFs (102). The centralized NRF (104) may build the local NRF table when the local NRF (102) registers with the centralized NRF (104).

By way of example, without limitations, Table 1 shown below illustrates a sample table in the centralized NRF (104). Table 1 includes columns associated with a priority value, a target PLMN, NF Type, slice number, an action to be taken, and an NRF table referring to NRF tables of local NRFs, other access technology independent network NRFs, or SEPP associated with the centralized NRF (104). The priority column may define priority value, such as, P1, P2, P3 . . . . PN wherein P1 may have the highest priority and PN may have the lowest priority. The higher priority rules are checked first. If two rules have same priority, the two rules are checked based on a serial number or an order of display. In one embodiment, the serial number or the order of display may be changed during runtime. The target PLMN column includes a PLMN number, for example, without limitations PLMN1, PLMN 2, . . . . PLMN N, associated with the PLMN to which the NF request is to be forwarded. If there are one or more PLMNs for which the request may be forwarded, the PLMN numbers are separated by a comma, wherein the comma signifies an OR operation. The target PLMN also includes a wildcard operator signifying to forward the request to any available PLMN. The NF Type corresponds to the type of NF request, for example, without limitations, an access and mobility management function (AMF) request, a session management function (SMF) request, or a 5G network data analytics function (NWDAF) request that may be acted upon. The NF Type column supports comma representing OR operation and an “ALL” value specifying the support for all types of NF request. The slice column includes slice number specified by single-network slice selection assistance information (S-NSSAI) values, for example, without limitations, slice 1, slice 2 . . . slice N, wherein one or more S-NSSAI values may be separated with a comma signifying OR operation and further includes a wildcard operator signifying any slice to which the request may be forwarded. For example, if the 4^{th} column is checking for slice value and * operator will mean that slice value can be anything and condition in that column will match. However, other column values present for same row will be checked for corresponding parameter. The action column specifies the action that needs to be taken, for example, whether to forward the request orreject the request. For example, if the action is specified as “forward,” the centralized NRF (104) may select a NRF Table as shown below in Table 2, wherein the name of the table to be referred for routing is specified in the NRF table column of Table 1. If the action is specified as “reject,” a user defined reject status code and a problem statement may be selected and may be included in a response to the NF request.

TABLE 1

| | Target | NF | | | NRF |
|---|---|---|---|---|---|
| Priority | PLMN | Type | Slice | Action | Table |
| P1 | PLMN 1 | AMF, SMF | Slice 1-n | Forward | NRFT1 |
| P2 | PLMN1, | All | Slice 1, | Forward | NRFT2 |
| | PLMN 2 | | slice 2, | | |
| | | | slice n | | |
| P3 | PLMN 3 | NWDAF | * | Reject | |
| P4 | PLMN 4 | All | * | Forward | NRFT3 |
| P5 | * | All | * | Forward | SEPPT |

Table 2 specifies the columns and the corresponding values associated with the NRF tables, for example, NRFT1, NRFT2, NRFT3 as specified under NRF table column of Table 1. The sample NRF table (Table 2) includes a first column specifying the name of the NRF table, a second column specifying the NRFs associated with the particular NRF table, a priority column specifying a priority value assigned with each NRF, and a weight column specifying a weightage given for NRFs with equal priority. The NRF table includes the local NRFs and may also include NRFs associated with other access technology independent networks and SEPP information.

By way for example, without limitations, the centralized NRF (104) may forward a NF request based on routing Tables 1 and 2. If the centralized NRF (104) receives a NF request with NF Type=AMF, the centralized NRF (104) may decide to forward the request to any NRF associated with the NRF table NRFT1. The table NRFT1 (shown in Table 2) includes NRF1 and NRF2, where NRF1 has a higher priority than NRF2. The centralized NRF (104) may then decide to forward the AMF request to NRF1 associated with target PLMN 1

TABLE 2

| NRF Table Name | NRFs | Priority | Weight |
|---|---|---|---|
| NRFT1 | NRF1 | P1 | W1 |
| | NRF2 | P2 | W2 |
| NRFT3 | NRF2 | P1 | W3 |
| | NRF3 | | W4 |
| | NRF4 | P3 | W1 |
| NRFT3 | SCNRF1 | P1 | W2 |
| | SCNRF2 | | W4 |
| | SEPP1 | P2 | W3 |
| | SEPP2 | P3 | W5 |
| SEPPT | SEPP1 | P1 | W3 |
| | SEPP2 | | W3 |

Referring to FIG. 1, the roaming partners (110) may include other PLMNs which may be connected with the serving PLMN through the SEPP (108). If the NF request needs to be forwarded to any of the RPs (110), the centralized NRF (104) may do so based on an IP address and port number associated with the SEPP (108).

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network (100) may perform functions described as being performed by one or more other components of the network (100).

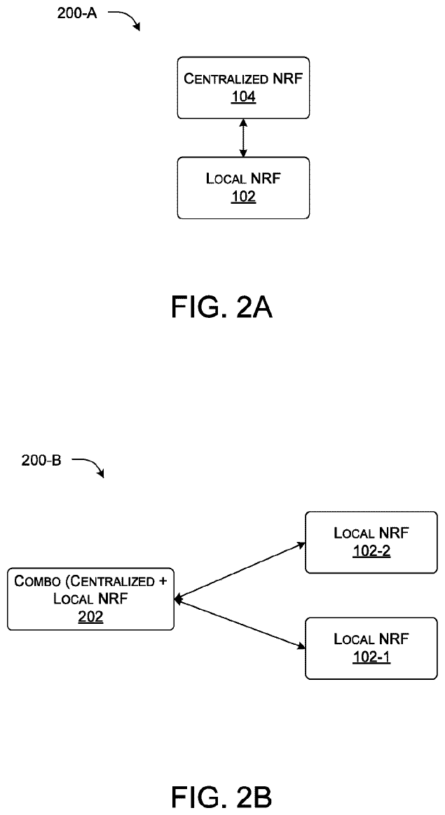

FIG. 2A illustrates an exemplary multi-tiered NRF hierarchy (200-A), in accordance with an embodiment of the present disclosure. FIG. 2A is described with reference to the elements to FIG. 1.

In FIG. 2A, a two-tier or a two-level NRF architecture (200-A) is shown. The first level includes one or more local NRFs (102) and the second level includes the centralized NRF (104). The local NRF (102) may have an option of selecting the IPs/ports (in Active Standby mode) for the centralized NRF (104) and define IP/port for multiple NRFs in a priority order such that if a primary IP of the centralized NRF is not reachable, the secondary IP of the same centralized NRF (104) may be tried. The NF request from the local NRF (102) may be forwarded to other NRFs or SEPPs (108) by the centralized NRF (104). The centralized NRF (104) may maintain an inventory for all NFs related to, for example, without limitations, creation, modification, deletion, and reporting status associated with the NFs.

In an embodiment, the centralized NRF (104) may maintain a subscription state data to be shared in real time between all the centralized NRFs (104-1 . . . 104-n) within the same PLMN. Centralized NRFs (104-1 . . . 104-n) may register with each other to enable sharing. The subscription state data may include subscriptions created by local NRFs (102), for example, Subscription ID data with associated local NRF (102), but requested by SEPPs (108) or other access technology independent network NRFs (106). The centralized NRF (104) may maintain this data based on a timer value defined as (Validity Time+Delta time), wherein the delta time may be configured by the user. In another embodiment, the Subscription ID generated by local NRFs (102) for the NF within the same PLMN (bypassing centralized NRF (104)) may or may not be stored by the centralized NRF (104).

By way of example, without limitations, the centralized NRF (104), upon receiving a patch Subscribe or UnSubscribe request from the SEPP (108) or other access technology independent network NRFs (106), may use the stored subscription state data to find the appropriate local NRF (102) and forward the request accordingly. In case the centralized NRF (104) is not able to find the subscription state data, it may reject the request with user configured status code and problem detail.

In some embodiments, the centralized NRF (104) may be deployed independently. In such scenario, the centralized NRF (104) may store the subscription state data depending on the origin of the NF request and how it is responded.

In a first example scenario, a Subscription ID request from the local NF i.e., the NF from the serving PLMN is sent to the local NRF1 (102-1) and the local NRF1 (102-1) is able to serve the subscription request, then response may be sent back to NF with associated Subscription ID and location header.

In a second scenario, when the subscription ID request from the local NF is sent to the local NRF1 (102-1) and the local NRF1 (102-1) is unable to serve the request and may decide to forward the request to the centralized NRF2 (104-2). The centralized NRF2 (104-2) may check its route table (Table 1 and Table 2 discussed above with reference to FIG. 1) and forward the request to the local NRF3 (102-3). The local NRF3 (102-3) shall generate the Subscription ID along with a corresponding location header (associated with NRF3) and send a response back to the local NF through the centralized NRF2 (104-2) and the local NRF1 (102-1) and finally to the local NF. The centralized NRF2 (104-2) may store the subscription state data upon receiving the response from the local NRF3 (102-3). The centralized NRF2 (104-2) and the local NRF1 (102-1) may not modify either subscription ID or location header in response. The NF, upon receiving the response, may forward subsequently, Subscribe Patch/UnSubscribe request directly towards application program interface (API) root provided by the location header i.e. the local NRF3 (102-3).

In a third scenario, when the subscription ID request is received from the local NRF associated with the SEPP (108) or other PLMN NRF, the centralized NRF2 (104-2) may identify the local NRF (102) based on the routing table and forward the request to the local NRF3 (102-3). The local NRF3 (102-3) may generate the Subscription ID and location header associated with the local NRF3 (102-3) and send the response back to the centralized NRF2 (104-2), wherein the centralized NRF2 (104-2) may store the subscription state data. The centralized NRF2 (104-2) may change the location header API root to the centralized NRF2 (104-2) before forwarding the response back to the SEPP (108) or other PLMN NRF. Subsequent Subscribe Patch or UnSubscribe request from the SEPP (108) may be received by the centralized NRF (104-2) which may further check the subscription state data to find the associated local NRF to forward the request to.

In a fourth scenario, when the subscription ID request is generated from the local NF for SEPP (108) or other PLMN NRF through the local NRF1 (102-1) and the centralized NRF2 (104-2), the local NRF1 (102-1) may initially receive the subscription request, and based on the PLMN the local NRF1 (102-1) may decide to forward the request towards the centralized NRF2 (104-2). The centralized NRF2 (104-2) again, based on target PLMN, may decide to forward the request towards the SEPP (108) or other access technology independent network NRF (106). The other access technology independent network NRF (106) or the NRF in RP (110) PLMN may generate the Subscription ID and forward the response to the centralized NRF2 (104-2) cither via the SEPP (108) or directly. In this case, the centralized NRF2 (104-2) may not save the subscription state data and instead may append the mobile country code (MCC)/mobile network code (MNC) to the subscription ID and make changes to the location header before forwarding the response back to the local NRF1 (102-1), wherein the local NRF1 (102-1) may make changes to the location header before forwarding the response back to the local NF.

FIG. 2B illustrates an exemplary multi-tiered NRF hierarchy (200-B) with a combinational NRF, in accordance with an embodiment of the present disclosure. FIG. 2B is illustrated with reference to entities of FIG. 1.

In FIG. 2B, two local NRFs (102-1, 102-2) are shown to be connected to a combinational NRF (202). The combination NRF (202) includes the centralized NRF (104) deployed as a separate logical entity within a local NRF container i.e., one single container holding both local and centralized NRFs. In some embodiments, the NRF may provide an option to select a mode of operation for the NRF, for example, the NRF may be either a local NRF or a centralized NRF or a combinational NRF. For example, without limitations, the NRF may provide a start-up configurable parameter related to a NRF deployment mode defined as “NRF Dep Mode” with possible values including “Single NRF.” “Local NRF.” “Centralized NRF.” and “Combo NRF.” The default value may be “Single NRF.” However, when “NRF Dep Mode” is “Local NRF.” the NRF should provide features of dual-tier local NRF, similarly when “NRF Dep Mode” is “Centralized NRF,” the NRF should provide features of dual-tier centralized NRF, and when “NRF Dep Mode” is “Combo NRF,” the NRF should provide support for both local and centralized NRF.

By way of example, without limitations, in the combinational NRF (202), the centralized NRF may have at most two IP/port combination, and the local NRF and the centralized NRF may act as two different NRFs sharing a database (DB) in real time. Further, the configuration file and parameters of the centralized NRF may be separated from that of the local NRF. In an embodiment, when the centralized NRFs (104) are deployed in Active-Active mode or Active-Standby mode, the subscription state data may be replicated between two centralized NRFs (104) enabling the communication between centralized NRFs (104) across vendors.

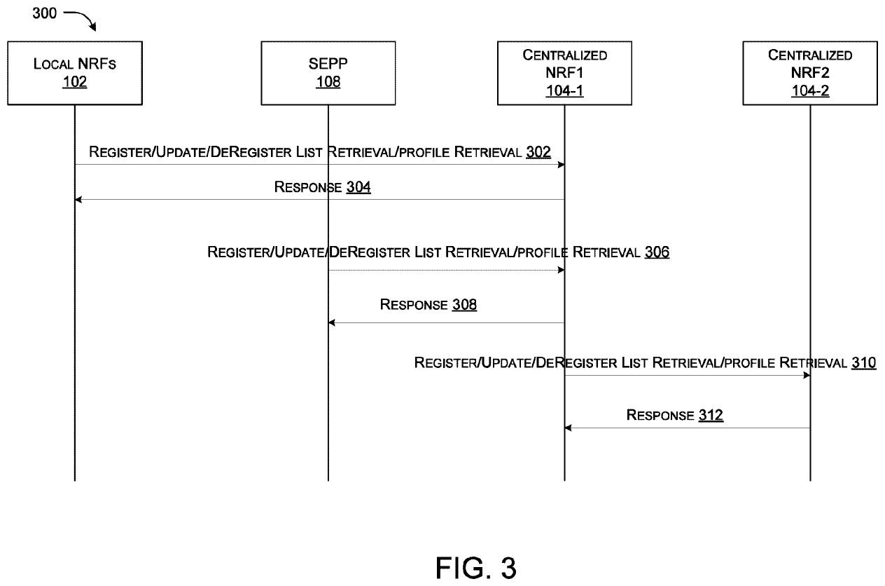

FIG. 3 illustrates an exemplary message flow diagram (300) associated with subscription messages between different entities in the 5G network architecture (100), in accordance with an embodiment of the present disclosure.

In FIG. 3, message sequence relating to Register/Update/DeRegister/List Retrieval/Profile Retrieval associated with one or more entities of the network (100) of FIG. 1, is shown. In an embodiment, the local NRF (102) may send a Register/Update/DeRegister/List Retrieval/Profile Retrieval request (302) to the centralized NRF1 (104-1) and receive a response (304) to the request. Similarly, the SEPP (108) may register with the centralized NRF1 (104-1) by sending a Register/Update/DeRegister/List Retrieval/Profile Retrieval request (306) which may be acknowledged by the centralized NRF1 (104-1) with a response (308). In some embodiments, the centralized NRF1 (104-1) may send a Register/Update/DeRegister/List Retrieval/Profile Retrieval request (310) to the centralized NRF2 (104-2) and receive a response (312) from the centralized NRF2 (104-2). The registration of one centralized NRF (e.g., 104-1) with another centralized NRF (e.g., 104-2) enables data sharing for routing the NF requests.

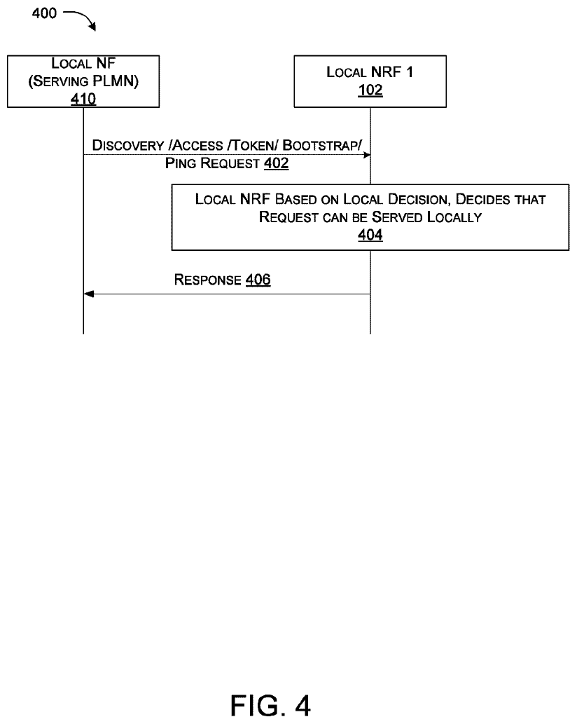

FIG. 4 illustrates an exemplary message flow diagram (400) associated with servicing a local NF in a PLMN by a local NRF, in accordance with an embodiment of the present disclosure.

In FIG. 4, messaging between a local NF (410) associated with a serving PLMN or the home PLMN and the local NRF1 (102-1) is shown. In one embodiment, the local NF (410) may initiate a Discovery/Access Token/Bootstrap/Ping Request (402) with the local NRF1 (102-1). The local NRF1 (102-1) may check for one or more information such as, but not limited to, the target PLMN, NF Type, slice number (S-NSSAI), etc. associated with the request (402) and determine (404) if the NF can be served by itself. Upon determining by the local NRF1 (102-1) that it may serve the NF (410), the local NRF1 (102-1) may send a response (406) to the NF (410).

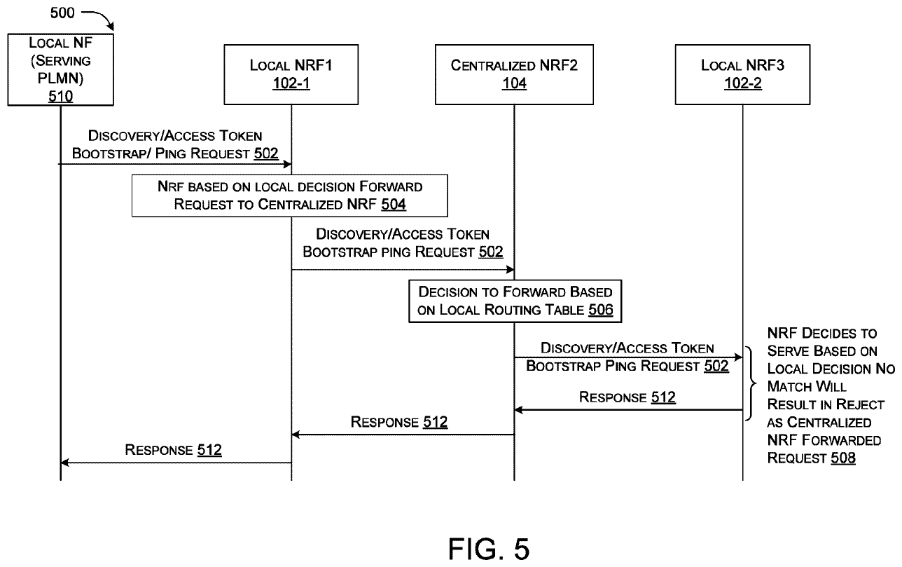

FIG. 5 illustrates an exemplary message flow diagram (500) associated with servicing the local NF in the PLMN by another local NRF, in accordance with an embodiment of the present disclosure.

In FIG. 5, the messaging between a local NF (510), a first local NRF1 (102-1), a centralized NRF2 (104), and a second local NRF3 (102-2) is shown. In an embodiment, the local NF (510) initiates a Discovery/Access Token/Bootstrap/Ping Request (502) towards the first local NRF1 (102-1). The first local NRF1 (102-1) may decide (504) based on one or more information such as, the target PLMN, NF Type, slice number (S-NSSAI), etc., associated with the request (502) and process the request (502). In an exemplary embodiment, the first local NRF1 (102-1) may decide (504) to forward the request (502) to the centralized NRF2 (104). The centralized NRF2 (104) decides (506) to forward the request to the second local NRF3 (102-2). The second local NRF3 (102-2), at step 508, determines to serve the request based on the local information, and send a response (512) back to the local NF (510) through the centralized NRF2 (104) and the first local NRF1 (102-1).

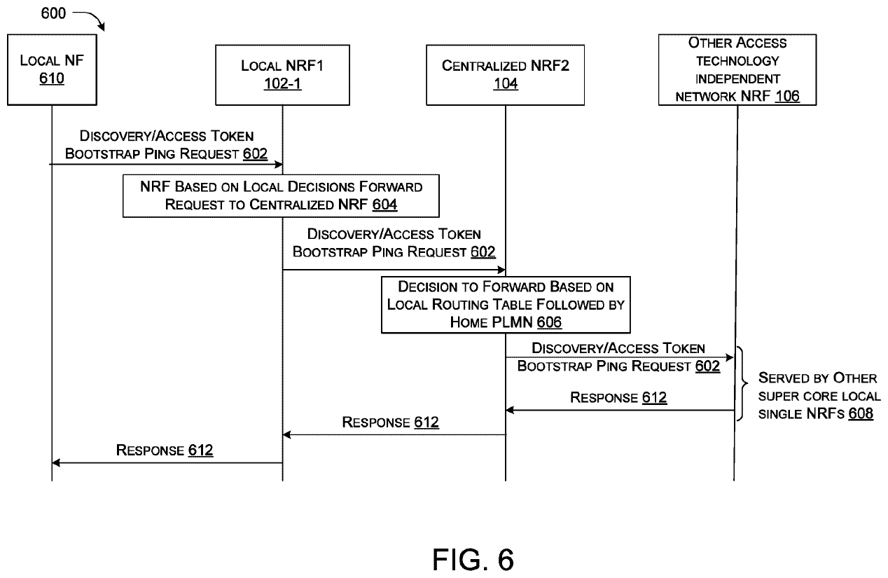

FIG. 6 illustrates an exemplary message flow diagram (600) associated with servicing the local NF in the serving PLMN by a local NRF of another access technology independent network, in accordance with an embodiment of the present disclosure.

In FIG. 6, messaging between a local NF (610), a first local NRF1 (102-1), a centralized NRF2 (104), and an access technology independent network NRF (106) is shown. In some embodiments, the local NF (610) initiates a Discovery/Access Token/Bootstrap/Ping Request (602) towards the first local NRF1 (102-1). The first local NRF1 (102-1) may decide (604), based on one or more information such as, the target PLMN, NF Type, slice number (S-NSSAI), etc. associated with the request (602) and process the request (602). In an exemplary embodiment, the first local NRF1 (102-1) may decide (604) to forward the request (602) to the centralized NRF2 (104). The centralized NRF2 (104) may decide (606) to forward the request to the other access technology independent network NRF (106) based on a routing table in the centralized NRF2 (104) and home PLMN details. The centralized NRF2 (104) may forward the request (602) to the other access technology independent network (106). The access technology independent network (106), at step 608, assigns any local NRF associated with it to process the request (602) and generate the response (612). The response (612) is communicated to the local NF (610) through the centralized NRF2 (104) and the first local NRF1 (102-1).

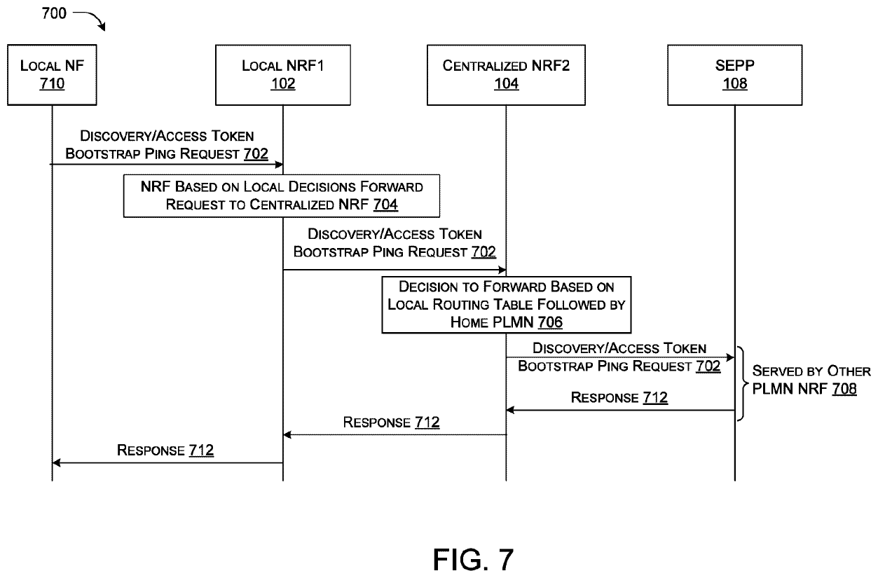

FIG. 7 illustrates an exemplary message flow diagram (700) associated with servicing the local NF in the PLMN by a local NRF in another PLMN, in accordance with an embodiment of the present disclosure.

In FIG. 7, messaging between a local NF (710), a first local NRF1 (102-1), a centralized NRF2 (104), and a SEPP (108) is shown. In some embodiments, the local NF (710) initiates a Discovery/Access Token/Bootstrap/Ping Request (702) towards the first local NRF1 (102-1). The first local NRF1 (102-1) may decide (704), based on one or more information such as, the target PLMN, NF Type, slice number (S-NSSAI), etc. associated with the request (702) and process the request (702). In an exemplary embodiment, the first local NRF1 (102-1) may decide (704) to forward the request (702) to the centralized NRF2 (104). The centralized NRF2 (104) may decide (708) to forward the request to the SEPP (108) based on a routing table and home PLMN details. The centralized NRF2 (104) may forward the request (702) to the SEPP (108). The SEPP (108), at step 708, assigns any local NRF associated with other PLMN to process the request (702) and generate the response (712). The response (712) is communicated to the local NF (710) through the centralized NRF2 (104) and the first local NRF1 (102-1).

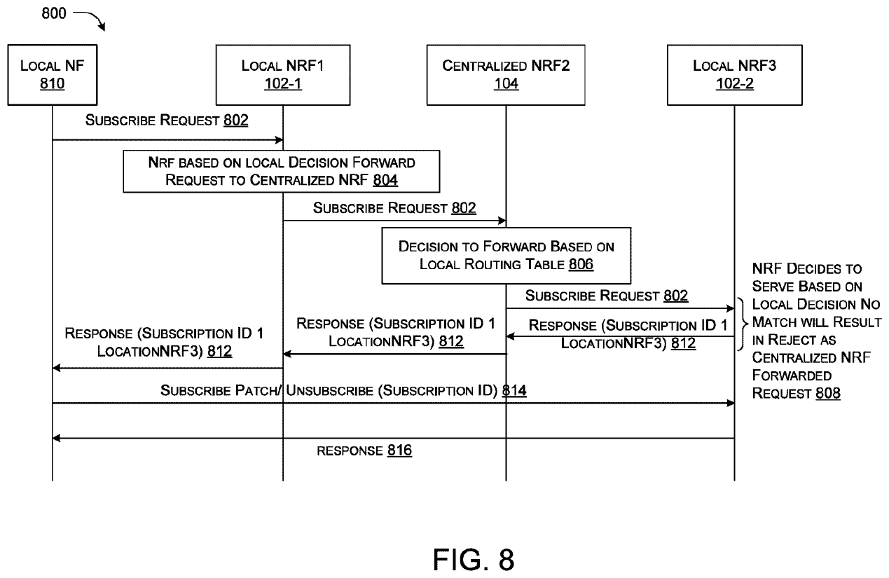

FIG. 8 illustrates an exemplary message flow diagram (800) associated with servicing a subscription request from the local NF in the PLMN by another local NRF, in accordance with an embodiment of the present disclosure.

In FIG. 8, messaging between a local NF (810), a first local NRF1 (102-1), a centralized NRF2 (104), and a second local NRF3 (102-2) is shown. The local NF (810) initiates a subscription request (802) to the first local NRF1 (102-1). The first local NRF1 (102-1) may decide (804) locally to forward the subscription request (802) to the centralized NRF2 (104). The centralized NRF2 (104) may decide (806) to forward the subscription request (802) to the second local NRF3 (102-2) based on a local routing table. The second local NRF3 (102-2), at step 808, decides to serve the NF request. The second local NRF3 (102-2) sends a response (812) to the local NF (810) through the centralized NRF2 (104) and the first local NRF1 (102-1). The response (812) includes a Subscription ID and a location identifier. For example, the location identifier may include the location of the serving local NRF3 (102-2). The local NF (810), upon receiving the response (812), may generate and send a Subscribe Patch/UnSubscribe message (814) to the second local NRF3 (102-2) and obtain a response (816). In some embodiments, the centralized NRF2 (104) may store the subscription state data upon receiving the response (812) from the second local NRF3 (102-2). The centralized NRF2 (104) and the first local NRF1 (102-1) may not modify either subscription ID or location header in the response (812). The local NF (810), upon receiving the response (812), may forward subsequently, Subscribe Patch/UnSubscribe request (814) directly towards API root provided by the location header i.e. the second local NRF3 (102-2).

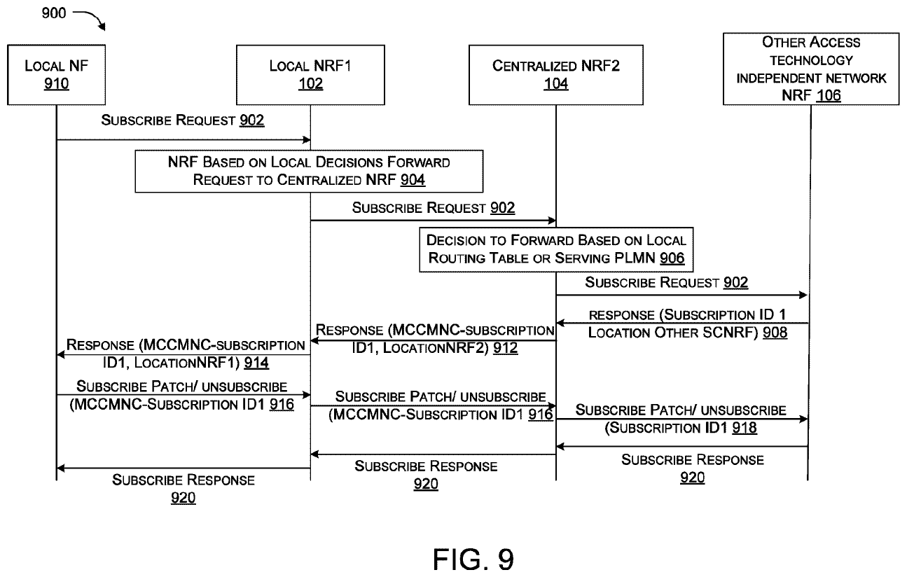

FIG. 9 illustrates an exemplary message flow diagram (900) associated with servicing a subscription request from the local NF in the PLMN by a local NRF of another access technology independent network, in accordance with an embodiment of the present disclosure.

In FIG. 9, messaging between a local NF (910), a local NRF1 (102), a centralized NRF2 (104), and other access technology independent network NRF (106) is shown. The local NF (910) initiates a subscription request (902) to the local NRF1 (102). The local NRF1 (102) may decide (904) locally to forward the subscription request (902) to the centralized NRF2 (104). The centralized NRF2 (104) may decide (906) to forward the subscription request (902) to other access technology independent network NRF (106) based on a local routing table and serving PLMN. The other access technology independent network NRF (106) decides to serve the NF (910) and sends a response (908) to the centralized NRF2 (104), wherein the response (908) includes the subscription ID and location information associated with the other access technology independent network NRF (106). The centralized NRF2 (104) modifies the response (908) to include a MCCMNC data related to another PLMN and modifies the location information to its own location. The modified response (912) is transmitted to the local NRF1 (102), wherein the local NRF1 (102) further modifies the response (912) to include the location of the local NRF1 (102) in the location information of the response (912). The further modified response (914) is sent to the local NF (910). The local NF (910), upon receiving the response (914), may generate and send a Subscribe Patch/UnSubscribe request (916) to the local NRF1 (102). The local NRF1 (102) forwards the request (916) to the centralized NRF2 (104). The centralized NRF2 (104) modifies the request (916) to remove the MCCMNC data and sends the modified request (918) to the other access technology independent network NRF (106). The other access technology independent network NRF (106) sends a subscribe response message (920) to the local NF (910) through the centralized NRF2 (104) and the local NRF1 (102).

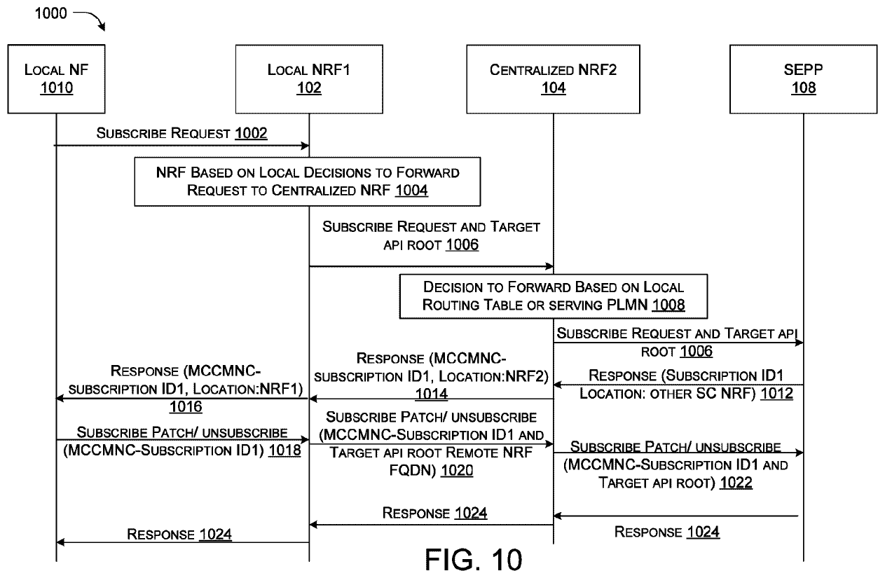

FIG. 10 illustrates an exemplary message flow diagram (1000) associated with servicing a subscription request from the local NF in the PLMN by a local NRF in another PLMN, in accordance with an embodiment of the present disclosure.

In FIG. 10, messaging between a local NF (1010), a local NRF1 (102), a centralized NRF2 (104), and other PLMN through the SEPP (108) is shown. The local NF (1010) initiates a subscription request (1002) to the local NRF1 (102). The local NRF1 (102) may decide (1004) locally to forward the subscription request along with API root (1006) to the centralized NRF2 (104). The centralized NRF2 (104) may decide (1008) to forward the subscription request with API root (1006) to the SEPP (108) based on a local routing table and serving PLMN. The SEPP (108) decides to serve the NF (1010) and sends a response (1012) to the centralized NRF2 (104), wherein the response (1012) includes the subscription ID and location information associated with the other SC NRF. The centralized NRF2 (104) modifies the response (1012) to include a MCCMNC data related to another PLMN and modifies the location information to its own location. The modified response (1014) is transmitted to the local NRF1 (102), wherein the local NRF1 (102) further modifies the response (1014) to include the location of the local NRF1 (102) in the location information of the response (1014). The further modified response (1016) is sent to the local NF (1010). The local NF (1010), upon receiving the response (1016), generates and sends a Subscribe Patch/UnSubscribe request (1018) to the local NRF1 (102). The local NRF1 (102) modifies the patch request (1018) to include a target API root and a Fully Qualified Domain Name (FQDN) associated with a remote NRF. The local NRF1 (102) forwards the modified subscribe patch request (1020) to the centralized NRF2 (104). The centralized NRF2 (104) further modifies the modified subscribe patch request (1020) to obtain a further modified patch request (1022) and sends the further modified patch request (1022) to the SEPP (108). The SEPP (108) send a response (1024) upon receiving the patch request (1022) to the local NF (1010) through the centralized NRF2 (104) and the local NRF1 (102).

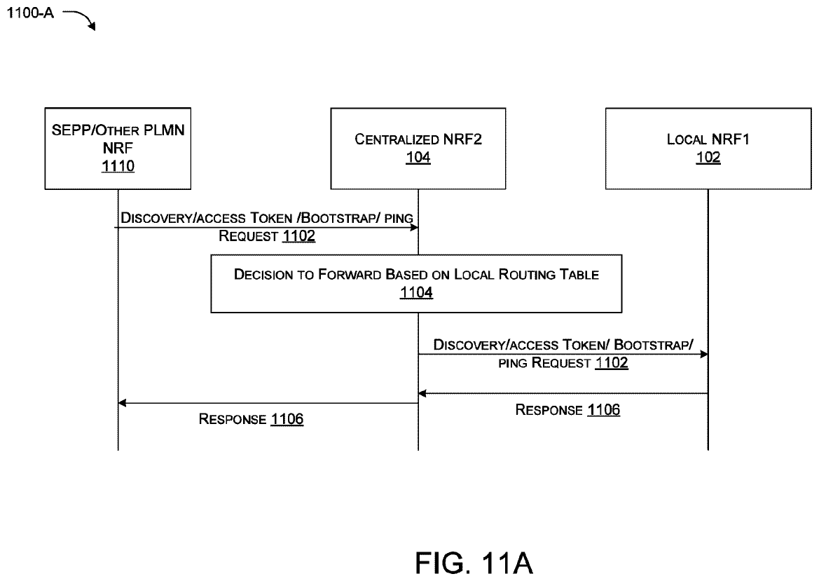

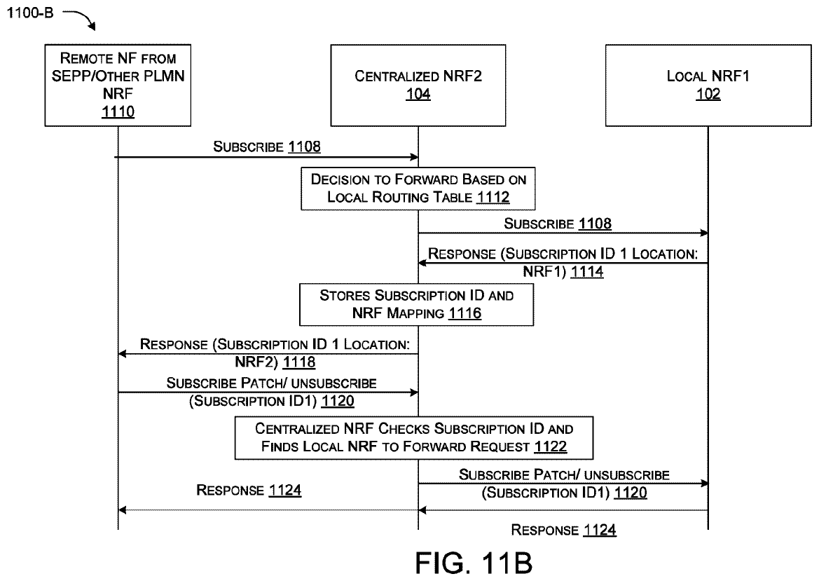

FIG. 11A illustrates an exemplary message flow diagram (1100-A) associated with remote NF discovery serviced by the local NRF, in accordance with an embodiment of the present disclosure.

In FIG. 11A, messaging between a remote NF (1110), a centralized NRF2 (104), and a local NRF1 (102) is shown. In an embodiment, the NF request (1102) associated with the SEPP (108)/an NRF in another PLMN is sent to the centralized NRF2 (104). The NF request (1102) may include a Discovery/Access Token/Boot Strap/Ping request. The centralized NRF2 (104), upon receiving the request (1102), at step 1104, checks for its local routing table and forwards the request (1102) to the local NRF1 (102). The local NRF1 (102) sends a response (1106) to the remote NF (1110) through the centralized NRF2 (104), wherein the response (1106) may specify that the local NRF1 (102) may provide service to the remote NF (1110).

FIG. 11B illustrates an exemplary message flow diagram (1100-B) associated with remote NF subscription request serviced by the local NRF, in accordance with an embodiment of the present disclosure.

In FIG. 11B, subscription request messages between a remote NF (1110), a centralized NRF2 (104), and a local NRF1 (102) is shown. In an embodiment, the subscription request (1108) from the remote NF (1110) associated with the SEPP (108)/an NRF in another PLMN is sent to the centralized NRF2 (104). The centralized NRF (104), upon receiving the request (1108), at step 1112, checks for its local routing table and forwards the request (1108) to the local NRF1 (102). The local NRF1 (102) sends a response (1114) to the centralized NRF2 (104), wherein the response (1114) includes a Subscription ID and location identifier, for example, the location identifier may include the location of the local NRF1 (102). The centralized NRF2 (104), at step 1116, stores the Subscription ID mapped to the local NRF (e.g., 102) sending the response (1114). The centralized NRF2 (104) modifies the response (1114) to include the location of the centralized NRF2 (104) and forwards the modified response (1118) to the remote NF (1110). Upon receiving the modified response (1118), the remote NF (1110) responds with a Subscribe Patch/Unsubscribe message (1120) to the centralized NRF2 (104). The centralized NRF2 (104), at step 1122, checks for the subscription ID in the Subscribe Patch/Unsubscribe message (1120) and forwards the same to the local NRF1 (102). The local NRF1 (102) sends a response (1124) to the remote NF (1110) through the centralized NRF2 (104).

Referring to the FIGS. 4-11B as discussed above, the terms local NRF1 (102), local NRF1 (102-1), and local NRF (102) may be used interchangeably and refer to any one local NRF in the network (100) of FIG. 1. Similarly, the terms centralized NRF (104), centralized NRF2 (104), and centralized NRF2 (104-2) may be used interchangeably and refer to any one centralized NRF (104) in the network (100). The term local NRF3 (102-2) or local NRF3 may be used interchangeably to represent a second local NRF to which the NF request is routed. In an embodiment, the second local NRF represented by the term local NRF3 may be associated with the same PLMN, a different PLMN, or a different access technology independent network.

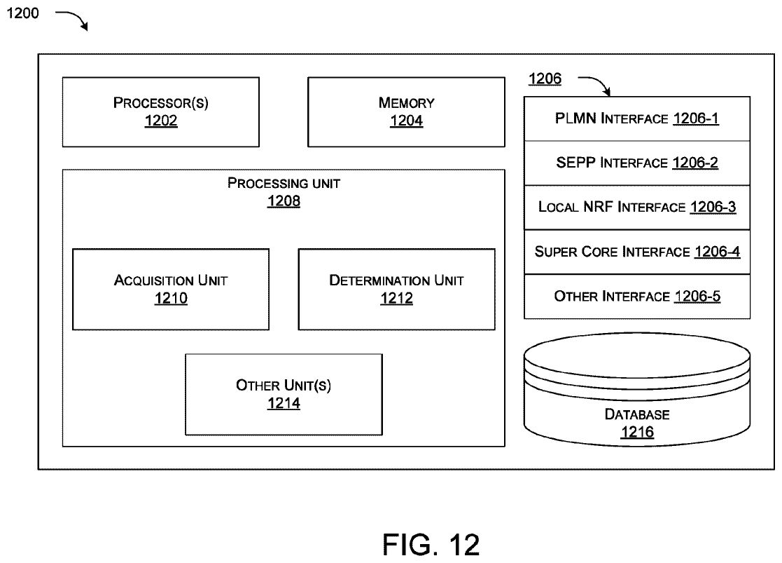

FIG. 12 illustrates an exemplary representation of a system (1200) with which or in which the centralized NRF (104) of FIG. 1 may be implemented, in accordance with an embodiment of the present disclosure.

For example, the system (1200) may include one or more processor(s) (1202). The one or more processor(s) (1202) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (1202) may be configured to fetch and execute computer-readable instructions stored in a memory (1204) of the system (1200). The memory (1204) may be configured to store one or more computer-readable instructions or routines in a non-transitory computer readable storage medium, which may be fetched and executed to create or share data packets over a network service. The memory (1204) may comprise any non-transitory storage device including, for example, volatile memory such as Random-Access Memory (RAM), or non-volatile memory such as Electrically Erasable Programmable Read-only Memory (EPROM), flash memory, and the like.

In an embodiment, the system (1200) may include an interface(s) (1206). The interface(s) (1206) may facilitate communication for the system (1200). The interface(s) (1206) may also provide a communication pathway for one or more components of the system (1200). Examples of such components include, but are not limited to, processing unit/engine(s) (1208) and a database (1216). Further, the interface(s) (1206) may comprise a variety of interfaces, such as, without limitations, a PLMN interface (1206-1), a SEPP interface (1206-2), a local NRF interface (1206-3), an access technology independent network interface (1206-4), and other interfaces (1206-5). In an embodiment, the interfaces (1206-1 . . . 1206-5) may be used for receiving input/transmitting output to other components or devices in the network (100) of FIG. 1. By way of example, without limitations, the PLMN interface (1206-1) may serve as a point to interact with the local PLMN and other PLMN or RPs (110) of FIG. 1, the SEPP interface (1206-2) may include communicating NF service request/response to/from NRFs in the other PLMNs, the local NRF interface (1206-3) may include sending/receiving NF request to/from the local NRF, the access technology independent network interface (1206-4) may include communication of NF request/response associated with the NRFs of other access technology independent networks (106) of FIG. 1, and the other interface(s) (1206-5) may include interfaces for data input and output devices, referred to as input/output (I/O) devices, storage devices, and the like.

The processing unit (1208) may be implemented as a combination of hardware and programming (for example, programmable instructions) to implement one or more functionalities of the processing unit (1208). In examples described herein, such combinations of hardware and programming may be implemented in several different ways. For example, the programming for the processing unit (1208) may be processor-executable instructions stored on a non-transitory machine-readable storage medium and the hardware for the processing unit (1208) may comprise a processing resource (for example, one or more processors), to execute such instructions. In the present examples, the machine-readable storage medium may store instructions that, when executed by the processing resource, implement the processing unit (1208). In such examples, the system (1200) may include the machine-readable storage medium storing the instructions and the processing resource to execute the instructions, or the machine-readable storage medium may be separate but accessible to the system (1200) and the processing resource. In other examples, the processing unit (1208) may be implemented by electronic circuitry. In an aspect, the database (1216) may comprise data that may be either stored or generated as a result of functionalities implemented by any of the components of the processor (1202) or the processing unit (1208).

In an embodiment, the processing unit (1208) may include units that receive communication from one or more network components in the network (100) of FIG. 1, such as receiving local NF service request associated with a local NRF (serving PLMN) or a remote NF receive request from a SEPP or an NRF associated with other PLMNs. The data associated with such request/response communication may be stored at the database (1216). In an embodiment, the processing unit (1208) may include one or more unite/modules such as, but not limited to, an acquisition unit (1210), a determination unit (1212), and other unit(s) (1214).

Referring to FIG. 12, the database (1216) may store the data associated with the request/response communication such as information related to route forwarding i.e., a routing table as discussed above with reference to FIG. 1, information related to the service request such as subscription ID associated with one or more NFs, etc. In an embodiment, the database (1216) may or may not reside in the system (1200). In an embodiment, the system (1200) may be operatively coupled with the database (1216).

Further, in an embodiment, the one or more processor(s) (1202) of the system (1200) may cause the acquisition unit (1212) to acquire NF request/response from the interfaces (1206) to extract Subscription ID and location parameter from the response message sent through the centralized NRF (104) and store the same in the database (1216). The stored information helps in routing NF service requests to appropriate NRFs by the centralized NRF (104).

Referring to FIG. 12, in an embodiment, the determination unit (1212) may determine a type of route for a particular NF service request. The determination unit (1212) may access the routing table (Tables 1 and 2 as discussed above) and PLMN list from the database (1216) to determine the route.

A person of ordinary skill in the art will appreciate that the exemplary representation (1200) may be modular and flexible to accommodate any kind of changes in the centralized NRF (104).

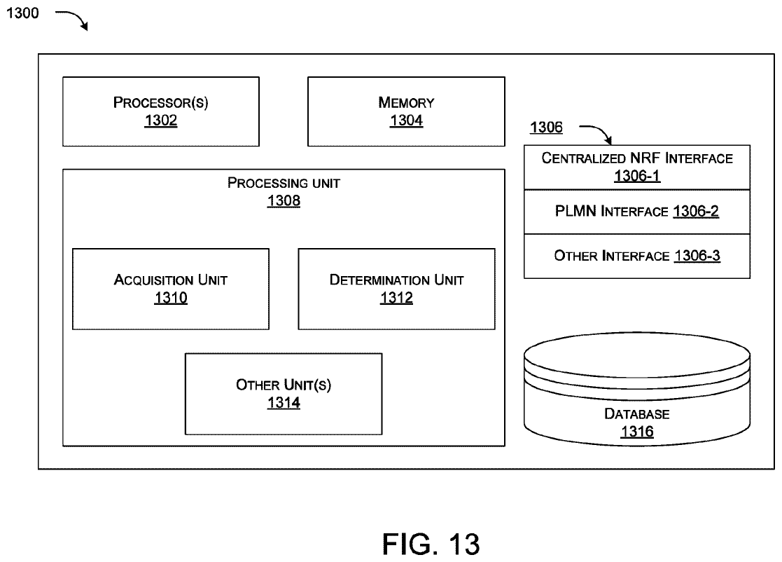

FIG. 13 illustrates an exemplary representation of a system (1300) with which or in which the local NRF (102) may be implemented, in accordance with an embodiment of the present disclosure. For example, the system (1300) may include one or more processor(s) (1302). The one or more processor(s) (1302) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (1302) may be configured to fetch and execute computer-readable instructions stored in a memory (1304) of the system (1300). The memory (1304) may be configured to store one or more computer-readable instructions or routines in a non-transitory computer readable storage medium, which may be fetched and executed to create or share data packets over a network service. The memory (1304) may comprise any non-transitory storage device including, for example, volatile memory such as Random-Access Memory (RAM), or non-volatile memory such as Electrically Erasable Programmable Read-only Memory (EPROM), flash memory, and the like.

In an embodiment, the system (1300) may include an interface(s) (1306). The interface(s) (1306) may facilitate communication for the system (1300) with other systems or units in the network (100) of FIG. 1. The interface(s) (1306) may also provide a communication pathway for one or more components of the system (1300). Examples of such components include, but are not limited to, processing unit/engine(s) (1308) and a database (1316). Further, the interface(s) (1306) may comprise a variety of interfaces, such as, without limitations a centralized NRF interface (1306-1), a PLMN interface (1306-2), and other interfaces (1306-3). In an embodiment, the interfaces (1306-1 . . . 1306-3) may be used for receiving input/transmitting output to other components or devices in the network (100) of FIG. 1. By way of example, without limitations, the centralized NRF interface (1306-1) may include sending/receiving registration request from the local NRF (102) and also for forwarding NF request for servicing or routing by the centralized NRF and receiving a response associated with the forwarded NF request. The PLMN interface (1306-2) may serve as a point to interact with the local PLMN and other PLMN to receive the NF request, and the other interface(s) (1306-3) may include interfaces for data input and output devices, referred to as input/output (I/O) devices, storage devices, and the like.

The processing unit (1308) may be implemented as a combination of hardware and programming (for example, programmable instructions) to implement one or more functionalities of the processing unit (1308). In examples described herein, such combinations of hardware and programming may be implemented in several different ways. For example, the programming for the processing unit (1308) may be processor-executable instructions stored on a non-transitory machine-readable storage medium and the hardware for the processing unit (1308) may comprise a processing resource (for example, one or more processors), to execute such instructions. In the present examples, the machine-readable storage medium may store instructions that, when executed by the processing resource, implement the processing unit (1308). In such examples, the system (1300) may include the machine-readable storage medium storing the instructions and the processing resource to execute the instructions, or the machine-readable storage medium may be separate but accessible to the system (1300) and the processing resource. In other examples, the processing unit (1308) may be implemented by electronic circuitry. In an aspect, the database (1316) may comprise data that may be either stored or generated as a result of functionalities implemented by any of the components of the processor (1302) or the processing unit (1308).

In an embodiment, the processing unit (1308) may include units that receive communication from one or more network components in the network (100) of FIG. 1, such as receiving local NF service request associated with a serving PLMN. The data associated with such request/response communication may be stored at the database (1316). In an embodiment, the processing unit (1308) may include one or more unite/modules such as, but not limited to, an acquisition unit (1310), a determination unit (1312), and other unit(s) (1314).

Referring to FIG. 13, the database (1316) may store the data associated with the request/response communication such as information related to route forwarding i.e., an IP address associated with the centralized NRF (104) for the local NRF (102) to forward the NF request that may not be serviced by itself to the centralized NRF (104). In an embodiment, the database (1316) may or may not reside in the system (1300). In an embodiment, the system (1300) may be operatively coupled with the database (1316).

Further, in an embodiment, the one or more processor(s) (1302) of the system (1300) may cause the acquisition unit (1312) to acquire NF request/response from the interfaces (1306) to extract target PLMN, slice number, NF request type, etc. from the NF service request to determine whether the NF request can be served locally or not. The stored information helps in routing NF service requests to the centralized NRF (104).

Referring to FIG. 13, in an embodiment, the determination unit (1312) may determine whether a particular NF service request may be serviced locally or needs to be forwarded to the centralized NRF (104). The determination unit (1212) may access target PLMN, slice number, and NF request type information from the NF service request and check whether the respective request may be serviced locally based on data parameters associated with the target PLMN, the slice number, and the NF request type as stored in the database (1316).

A person of ordinary skill in the art will appreciate that the exemplary representation (1300) may be modular and flexible to accommodate any kind of changes in the system (1300).

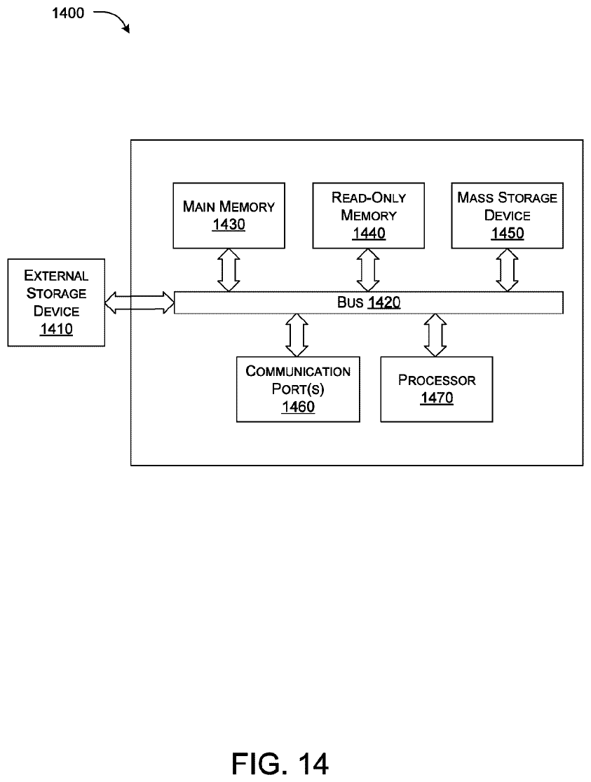

FIG. 14 illustrates an exemplary computer system (1400) in which or with which embodiments of the present disclosure may be implemented.

As shown in FIG. 14, the computer system (1400) may include an external storage device (1410), a bus (1420), a main memory (1430), a read-only memory (1440), a mass storage device (1450), communication port(s) (1460), and a processor (1470). A person skilled in the art will appreciate that the computer system (1400) may include more than one processor and communication ports. The processor (1470) may include various modules associated with embodiments of the present disclosure. The communication port(s) (1460) may be any of an RS-232 port for use with a modem-based dialup connection, a 10/100 Ethernet port, a Gigabit or 10 Gigabit port using copper or fiber, a serial port, a parallel port, or other existing or future ports. The communication port(s) (1460) may be chosen depending on a network, such a Local Area Network (LAN), Wide Area Network (WAN), or any network to which the computer system (1400) connects. The main memory (1430) may be random access memory (RAM), or any other dynamic storage device commonly known in the art. The read-only memory (1440) may be any static storage device(s) including, but not limited to, a Programmable Read Only Memory (PROM) chips for storing static information e.g., start-up or basic input/output system (BIOS) instructions for the processor (1470). The mass storage device (1450) may be any current or future mass storage solution, which may be used to store information and/or instructions.

The bus (1420) communicatively couples the processor (1470) with the other memory, storage, and communication blocks. The bus (1420) can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (1470) to the computer system (1400).

Optionally, operator and administrative interfaces, e.g. a display, keyboard, and a cursor control device, may also be coupled to the bus (1420) to support direct operator interaction with the computer system (1400). Other operator and administrative interfaces may be provided through network connections connected through the communication port(s) (1460). In no way should the aforementioned exemplary computer system (1400) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### Advantages of the Present Disclosure

The present disclosure provides a multi-tier network repository function (NRF) architecture with multiple NRFs in the same public land mobile network (PLMN).

The present disclosure provides a multi-tier NRF architecture for supporting multi slice for both shared/individual slices with multiple NRFs.

The present disclosure provides support for multiple NRFs in large mobile network operator (MNO) deployment.

The present disclosure provides a solution for routing of Subscribe Update/UnSubscribe message for multi-NRF scenario.

The present disclosure provides a centralized NRF as a network wide reporter or an inventory manager or a configuration manager.

The present disclosure provides a real time update as a centralized NRF manages data directly from one or more local NRFs.

The present disclosure provides the centralized NRF for communication with roaming partners (RPs) enabling future manageability for RPs.

The present disclosure provides a NRF forwarding policy.

The present disclosure provides ease of scalability for multiple NRF clusters.

The present disclosure provides a combinational NRF for smaller deployments.

The present disclosure facilitates to enhance the network management capabilities.

The present disclosure facilitates to optimize the network functions.

We claim:

1. A system (1300) for managing routing in a multi-tiered network repository function (NRF) architecture comprising a centralized NRF (104) associated with one or more local NRFs (102), said system (1300) comprising:
one or more processors (1302); and
a memory (1304) operatively coupled to the one or more processors (1302), wherein the memory (1304) comprises processor-executable instructions, which on execution, cause the one or more processors (1302) to:
receive an NF service request associated with a serving public land mobile network (PLMN);
determine whether the NF service request is processed by a local NRF of the one or more local NRFs (102); and
forward the NF service request to the centralized NRF (104) based on the local NRF (102) being unable to process the NF service request.

2. The system (1300) as claimed in claim 1, wherein the centralized NRF (104) serves as a gateway for servicing one or more NFs associated with a telecommunication network (100).

3. The system (1300) as claimed in claim 1, wherein the memory (1304) comprises processor-executable instructions, which on execution, cause the one or more processors (1302) to forward the NF service request to the centralized NRF (104) based on the NF service request being in a suspended state.

4. The system (1300) as claimed in claim 1, wherein the centralized NRF (104) routes an NF service request associated with a first local NRF (102-1) to a second local NRF (102-2) based on one or more routing tables associated with the centralized NRF (104).

5. The system (1300) as claimed in claim 4, wherein the first local NRF (102-1) and the second local NRF (102-2) are associated with the same PLMN.

6. The system (1300) as claimed in claim 4, wherein the first local NRF (102-1) is associated with a first PLMN and the second local NRF (102-2) is associated with a second PLMN.

7. The system (1300) as claimed in claim 6, wherein the second PLMN is associated with a roaming partner (RP) (110).

8. The system (1300) as claimed in claim 6, wherein the centralized NRF (104) routes the NF service request to the second local NRF (102-2) associated with the second PLMN through a security edge protection proxy (SEPP) (108).

9. The system (1300) as claimed in claim 1, wherein the centralized NRF (104) comprises at least one of: an independently deployed centralized NRF (104) or a combinational NRF (202).

10. The system (1300) as claimed in claim 9, wherein the combinational NRF (202) comprises the centralized NRF (104) deployed within at least the one or more local NRFs (102).

11. A method for routing a network function (NF) service request in a local network repository function (NRF) (102), said method comprising:
receiving, at a public land mobile network (PLMN) interface, the NF service request associated with a serving PLMN;
determining, by a determination unit (1312), based on one or more parameters whether the NF service request is processed by the local NRF (102); and
forwarding, through a centralized NRF interface (1306-1), the NF service request to a centralized NRF (104) based on the local NRF (102) being unable to process the NF service request.

12. The method as claimed in claim 11, comprising:
processing, by one or more processors (1302), the NF service requestat the local NRF (102) based on the one or more parameters.

13. The method as claimed in claim 11, wherein the one or more parameters comprise at least one of: a target PLMN, a single network slice selection assistance information (S-NSSAI), and a type of NF (NF Type).

14. A method for routing a network function (NF) service request in a centralized network repository function (NRF) (104), said method comprising:
receiving, at a local NRF interface (1206-3), the NF service request associated with a serving public land mobile network (PLMN) from a first local NRF (102-1);
determining, by a determination unit (1212), a route for the NF service request based on a routing table and PLMN information stored in a database (1216); and
forwarding, through the local NRF interface (1206-3), the NF service request to a second local NRF (102-2) based on the determined route.

15. The method as claimed in claim 14, wherein the routing table comprises information related to at least one of: a priority value, a target PLMN, a type of NF (NF Type), a slice number, an action, and an NRF table.

16. The method as claimed in claim 14, wherein the second local NRF (102-2) is associated with at least one of:
the serving PLMN;
a second access technology independent network (106-2); and
a roaming partner (RP) (110).

17. A non-transitory computer readable medium comprising one or more instructions stored thereupon that when executed by a processor causes the processor to:
receive a network function (NF) service request associated with a first local network repository function (NRF) (102-1) in a public land mobile network (PLMN);
determine a route for the NF service request to a second local NRF (102-2) based on a routing table and PLMN information from a database (1216); and
forward the NF service request to the second local NRF (102-2) based on the determined route.
